(19) United States
(12) Patent Application Publication
(10) Pub. No.: US 2014/0157253 A1
(43) Pub. Date: Jun. 5, 2014

(54) RETROFITTING A PROCESSOR CLUSTER

(71) Applicants: Prashant K. Padhy, Aurora, IL (US); Paul M. Susa, Naperville, IL (US); Vasumathi Narasimhan, Bangalore (IN); Ritu Sama, Bangalore (IN)

(72) Inventors: Prashant K. Padhy, Aurora, IL (US); Paul M. Susa, Naperville, IL (US); Vasumathi Narasimhan, Bangalore (IN); Ritu Sama, Bangalore (IN)

(73) Assignees: ALCATEL-LUCENT INDIA LIMITED, Bangalore (IN); ALCATEL-LUCENT USA INC., Murray Hill, NJ (US)

(21) Appl. No.: 14/008,975

(22) PCT Filed: Mar. 31, 2011
(86) PCT No.: PCT/US11/30687

§ 371 Date: Sep. 30, 2013

(51) Int. Cl. G06F 9/445

(52) U.S. Cl. CPC G06F 8/65
USPC 717/171

(57) ABSTRACT

A method for retrofitting a processor cluster with application software in a communication network is described herein. In one implementation, the method comprises dividing a processor cluster into a plurality of application processor groups, wherein the processor cluster comprises a plurality of application processors. The application software is retrofitted on an application processor group selected from the plurality of application processor groups, to obtain a retrofitted application processor group. Further, sessions of a subsequent application processor group are preserved on the retrofitted application processor group. The application software is retrofitted onto the subsequent application processor group.

The present subject matter relates to communication networks and, particularly but not exclusively, to retrofitting a processor cluster in a communication network.

### BACKGROUND

Typical telecommunication systems include one or more processor clusters for handling communication services, such as management of network resources and management of data traffic. Each processor cluster may include a plurality of application processors, where each application processor executes instances of one or more application software. Such application software may facilitate the telecommunication systems in managing the communication services in the communication network. With the ever-evolving technology, upgraded versions of the application software are continually introduced. Such upgraded versions are installed on the processor clusters to either provide new features and functionalities to the processor cluster, or update the present application software for enhancing performance of the processor cluster in handling communication services. The installation and activation of upgraded versions of the application software on the processor cluster is referred to as retrofitting.

Usually, an upgraded version of the application software is not backward compatible with the earlier versions. Hence, during retrofitting, it is undesirable to have different application processors, in a processor cluster, running different versions of the application software. To avoid such a situation, the retrofitting is achieved simultaneously on each of the plurality of application processors in the processor cluster. Such conventional schemes of retrofitting a processor cluster with the application software may generally involve interrupting communication services handled by the processor cluster by taking all the application processors offline. Subsequently, all the application processors in the processor cluster are retrofitted with the application software.

### SUMMARY

This summary is provided to introduce concepts related to retrofitting a processor cluster with application software, in a communication network. This summary is not intended to identify essential features of the claimed subject matter nor is it intended for use in determining or limiting the scope of the claimed subject matter.

A method for retrofitting a processor cluster with application software in a communication network is described herein. In an implementation, the method comprises dividing the processor cluster into a plurality of application processor groups, wherein the processor cluster comprises a plurality of application processors. The application software is retrofitted on an application processor group selected from the plurality of application processor groups, to obtain a retrofitted application processor group. Further, sessions of a subsequent application processor group are preserved on the retrofitted application processor group. Furthermore, the application software is retrofitted onto the subsequent application processor group.

### BRIEF DESCRIPTION OF THE FIGURES

The detailed description is described with reference to the accompanying figures. In the figures, the left-most digit(s) of a reference number identifies the figure in which the reference number first appears. The same numbers are used throughout the figures to reference like features and components.

Some embodiments of system and/or methods in accordance with the present subject matter are now described, by way of example only, and with reference to the accompanying figures, in which:

FIG. 1 illustrates a telecommunication system implementing retrofitting of a processor cluster, according to an embodiment of the present subject matter;

FIG. 2 illustrates a retrofitting device to retrofit a processor cluster in a communication network within the telecommunication system, according to an embodiment of the present subject matter; and

FIG. 3 illustrates an exemplary method for retrofitting a processor cluster in the communication network, according to an embodiment of the present subject matter.

It should be appreciated by those skilled in the art that block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

### DESCRIPTION OF EMBODIMENTS

Systems and methods for retrofitting a processor cluster are described herein. A typical telecommunication system may implement a communication network to allow communication between various terminal devices, for example, mobile phones and pagers. The communication network, generally, includes various network entities for performing one or more functions for establishing communication between the terminal devices. For example, a Global System for Mobile Communication (GSM) network includes a base station subsystem having one or more base station controllers (BSCs) and a switching subsystem having one or more main switching centers (MSCs). In another example, a Universal Mobile Telecommunications System (UMTS) network includes a radio access network (RAN) having one or more radio network controllers (RNCs).

The network entities may include a plurality of processor clusters. Such processor clusters may further include a plurality of application processors, which facilitate handling of variety of communication services, such as voice calls, data calls, and short message service (SMS), and data related to such communication services. The processor clusters in the communication network allows execution of a number of instances of the application software.

To introduce new functionalities or to supplement the features and functionalities of the telecommunication systems, upgraded versions of application software are developed, and installed periodically. The network entities, such as the BSCs, the RNCs, and the MSCs, can be implemented or retrofitted with the upgraded version of the application software to enhance the operation of or implement additional functionalities within the telecommunication system.

Generally, retrofitting of a processor cluster handling communication services over a communication network can be achieved by taking all the application processors within the processor cluster offline, followed by retrofitting the application processors. An application processor is said to be offline when active connections between the application processor and other application processors within the processor cluster or the active connections between the application processor and terminal devices, such as mobile phones and pagers, are terminated. At this stage, the application processor is operationally deactivated. While taking the application processors offline, the functions being performed by the application processors may be suspended and therefore, data associated with the active connections between the application processors and the terminal devices may get temporarily or permanently lost. Other systems and methods may involve dividing the processor cluster into two application processor groups. Subsequently, one application processor group can be taken offline and retrofitted with the intended application software or updated version of the application software. Once retrofitted, the application group can be isolated so that the application processor group does not interfere with the other application processor group, which is running a different version of the application software. While the recently updated application processor group is still in isolation, the second processor group is taken offline for retrofitting. Subsequently, the recently updated application processor group can be brought online. It will be understood that an application processor group is said to be online when it is actively connected to other application processor groups and to the various terminal devices, and its functionalities are resumed.

However, such conventional methods experience a finite downtime, for example, when the recently updated application processor group is isolated and the other application processor group is taken offline. Further, to restore the connectivity among the terminal devices post retrofitting, the terminal devices may require re-registering with the communication network when either of the application processor groups of the communication network comes online. As a result of the re-registering, the terminal devices may experience additional downtime. In addition, with the high number of terminal devices re-registering simultaneously, the access channels of the communication network may get overloaded and may adversely impact the quality of communication services managed by the processor cluster. As a result, the communication among various terminal devices, for example, mobile phones, connected and operating through the application processor groups, may get affected, and in turn affect the capability of the communication network.

To this end, embodiments of the present subject matter describe methods and systems for retrofitting a plurality of application processors within a processor cluster with application software. Examples of the application software may include, but are not limited to, application software for implementing any additional functionality, a new version or release of the application software, patches, and updates for a presently hosted application software. Further, the application software can be understood to be one application software or a plurality of application software or modules implementing various functionalities. In an embodiment, the processor cluster is included within a network entity in a telecommunication system, and handles communication services of the telecommunication system. As indicated previously, examples of such a network entity, includes but are not limited to a BSC, an MSC, and an RNC.

The systems and methods described herein can be implemented in any of the communication networks, such as Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), and IP-based network, Public Switched Telephone Network (PSTN), Long Term Evolution (LTE) network, and Integrated Services Digital Network (ISDN). Although the description herein is with reference to certain networks, the systems and methods may be implemented in other networks, albeit with a few variations, as will be understood by a person skilled in the art.

In one implementation, the retrofitting process includes dividing the plurality of the application processors into one or more application processor groups. The division of the processor cluster into the plurality of application processor groups can be based on various schemes. In one implementation, the processor cluster can be divided into a plurality of application processor groups based on configurations of the application processors. For example, one group may include active application processors, while the other group(s) may include standby application processors. In another implementation, the processor cluster is divided based on numerical identifiers of the application processors. In such a case, the processor cluster can be divided into a first application processor group which includes application processors having even numbered numerical identifiers, and into a second application processor group which includes application processors having odd numbered numerical identifiers. In yet another implementation, the processor cluster is divided into the plurality of application processor groups based on both, the numerical identifiers associated with the application processors as well as the configurations of the application processors. For example, the first application processor group may include even numbered processors that are in active configuration and the second application processor group may include odd numbered application processors that are in standby configuration.

Once divided, the application software is retrofitted onto one or more of the application processor groups. In one implementation, few of the application processor groups, such as a first application processor group, can be initially retrofitted with the application software. The retrofitted application processor groups, such as the first application processor group, can then be isolated from the remaining of the application processor groups. When isolated, the functionalities and operations of the retrofitted application processor group may cease and the interaction between the application software on the retrofitted application processor group and the remaining application processor groups are disabled. This may be done to ensure that the recently updated application software on the retrofitted application processor group does not interfere with the previously existing application software on other application processor groups. Subsequently, the application software is initialized or activated on the retrofitted application processor group.

In one implementation, the retrofitting of the application software can be initiated first for those application processor groups that are in a standby configuration. When in the standby configuration one or more application processors are in a ready-to-run state but may not be handling any telecommunication based operations. It would be appreciated by a person skilled in the art that the retrofitting of the application processor groups can also be initiated with the active application processors without deviating from the scope of the present subject matter. In such a case, all processes being handled by the application processor group to be retrofitted can be switched to other application processor groups within the processor cluster. The application processor group can then be retrofitted with the desired application software.

To further the retrofitting process for the remaining application processors in the processor cluster, in an implementation, a subsequent application processor group for retrofitting can then be identified. Once identified, the session data, corresponding to the processes being handled by the subsequent application processor group, is preserved. In one implementation, the session data can be preserved on the retrofitted application processor group. In such a case, information associated with sessions and processes handled by the subsequent application processor group can be stored on the retrofitted application processor group. Such information can include session data, for example, active call session data and active packet exchange session data, associated with the subsequent application processor group. Once the session data is preserved, the control is switched from the subsequent application processor group to the retrofitted application processor group. In this manner, the sessions and the functionalities being serviced by the subsequent application processor group are transferred onto the recently retrofitted application processor group. It will be understood that the switching of control between two application processor groups may include switching the control of active processes from one application processor group onto the other application processor group.

With the switching of control, the retrofitted application processor group is made operational to handle sessions of the subsequent application processor group. The other application processor groups are then subsequently retrofitted in the manner as described above. In this manner, all the application processors within the application processor groups can be retrofitted.

In an implementation, when the retrofitted application processor group is made operational to service the terminal devices, the retrofitted application processor group remains isolated from the rest of the processor cluster to prevent any communication between the retrofitted application processor group running one version of the application software and the other application processors running a different version of the application software. In another implementation, as soon as the retrofitted application processor group is isolated from the rest of the application processors in the processor cluster and the application software is activated, the sessions running on all other application processor groups in the processor cluster are preserved on the retrofitted application processor group. In said implementation, the other application processor groups are, subsequently brought offline and retrofitted with the application software, whereas the retrofitted application processor group is made operational to handle the sessions associated with the other application processor groups.

The retrofitting achieved according to the present subject matter eliminates interruption of the communication processes serviced by the processor cluster. As a result, the impact of the retrofitting on the services provided by the communication network to various terminal devices is minimized as the sessions of one application processor group are preserved on a subsequent application processor group. With the preservation of the sessions, re-building the session information of the terminal devices is not required, which avoids loss of service to the terminal devices.

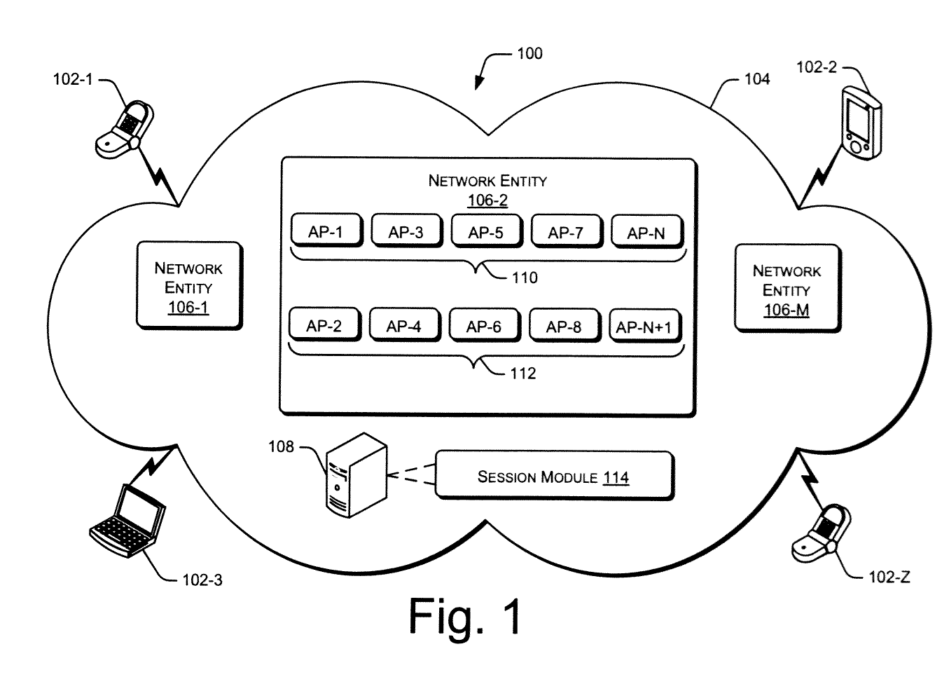

These and other aspects in relation to the retrofitting of a processor cluster with application software shall be explained in detail with respect to FIG. 1 through FIG. 3. While aspects of systems and methods can be implemented in any number of different systems, environments, and/or configurations, the embodiments are described in the context of the following exemplary system architecture(s).

It should be noted that the description and figures merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and the concepts contributed by the inventor(s) to furthering the art, and are to be construed as being without limitation to such specifically recited examples and conditions. Moreover, all statements herein reciting principles, aspects, and embodiments of the present subject matter, as well as specific examples thereof, are intended to encompass equivalents thereof.

It will also be appreciated by those skilled in the art that the words during, while, and when as used herein are not exact terms that mean an action takes place instantly upon an initiating action but that there may be some small but reasonable delay, such as a propagation delay, between the initial action and the reaction that is initiated by the initial action. Additionally, the word “connected” is used throughout for clarity of the description and can include either a direct connection or an indirect connection.

FIG. 1 illustrates a telecommunication system 100 for retrofitting a processor cluster with application software, according to an embodiment of the present subject matter. In an embodiment, the telecommunication system 100 includes one or more communication devices 102-1, 102-2, 102-3, . . . , 102-Z (collectively referred to as communication devices 102) communicating with each other through a communication network 104. The communication devices 102 may include, without limitation, desktop computers, hand-held devices, laptops or other portable computers, network computers, mobile phones, landline phones, and the like. Each of the communication devices 102 communicate with each other based on communication protocols implemented by the communication network 104.

The communication network 104 may be a wireless or a wired network, or a combination thereof. The communication network 104 can be a collection of individual networks that are interconnected with each other and functioning as a single large network (e.g., the internet or an intranet). Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), IP-based network, Public Switched Telephone Network (PSTN), Long Term Evolution (LTE) network and Integrated Services Digital Network (ISDN).

Depending on the technology, the communication network 104 includes various network entities 106-1, 106-2, . . . 106-M, collectively referred to as network entities 106 and individually referred to as a network entity 106. In one example, where the communication network 104 is a GSM network, the network entities 106 include one or more mobile switching centres (MSCs) and base station controllers (BSCs). In another example, where the communication network 104 is a UMTS network, the network entities 106 include one or more radio network controllers (RNCs).

Each of the network entities 106, such as network entity 106-2 as illustrated in FIG. 1, includes at least one processor cluster having a plurality of application processors AP-1, AP-2, . . . AP-N+1. In one example, N is an odd integer. The plurality of application processors execute one or more application software to provide communication related services, such as signaling, data traffic processing, and call processing, to end users of the communication devices 102. The application software may also be implemented to provide one or more functionalities to the communication network 104.

As indicated previously, to enhance the functionalities of the telecommunication system 100 and to provide additional features, the application processors in the processor cluster are retrofitted or upgraded with programs associated with the application software running on the application processors. Examples of the programs may include, but are not limited to, application software for implementing any additional functionality, a new version or release of the application software, patches, and updates. Further, the programs can be understood to be one application software or a plurality of application software or modules implementing various functionalities. For the purpose of explanation, such programs associated with application software are also referred to as application software, hereinafter.

The communication network 104 further includes a retrofitting device 108. In one embodiment, each network entity 106 is provided with a dedicated retrofitting device 108. In another implementation, the retrofitting device 108 can be communicatively connected to all the network entities 106 within the communication network 104.

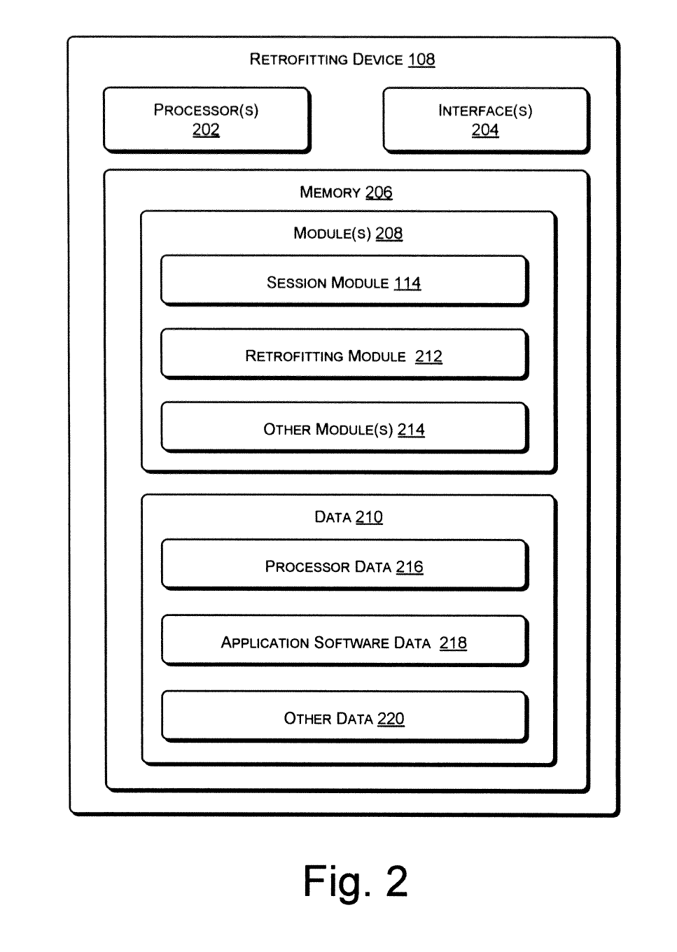

In one embodiment, the retrofitting device 108 initiates the retrofitting of the processor cluster by dividing the processor cluster into a plurality of application processor groups. It will be understood that the division of the processor cluster includes a logical division of the processor cluster into the application processor groups. In one implementation, the retrofitting device 108 divides the processor cluster into two processor groups, say, a first application processor group 110 and a second application processor group 112. For example, the retrofitting device 108 may divide the processor cluster in a manner such that the even numbered application processors, i.e. application processors AP-2, AP-4 . . . AP-N+1, are categorized as the first application processor group 110, and the odd numbered application processors, i.e. application processors AP-1, AP-5, . . . AP-N, are categorized as the second application processor group 112. In an embodiment, the retrofitting device 108 divides the processor cluster into the application processor groups based on numerical identifiers associated with the application processors or the configuration of the application processors, or a combination thereof. The division of the processor cluster into the plurality of the application processor groups is described in detail with reference to FIG. 2.

Subsequent to the division of the processor cluster into application processor groups, the retrofitting device 108 commences the installation of the application software on one of the application processor group, for example, the first application processor group 110. The application processor group having the application software installed thereon is also referred to as retrofitted application processor group. After the application software is installed, the retrofitting device 108 isolates the retrofitted application processor group, in this case the first application processor group 110, from the other application processors within the processor cluster that have not yet been updated with the application software. Upon isolation, the retrofitting device 108 may initialize the application software on the retrofitted application processor group, for example, the first application processor group 110. It will be understood that the isolation of the application processor group implies an operational isolation, where the application processor group is logically isolated from the processor cluster and may be operational. The isolation is achieved to avoid any interaction of the processes of one version of the application software on the application processor group with the processes of another version of the application software on the rest of the application processor groups. Once initialized, the application software on the retrofitted first application processor group 110 is in a ready-to-run state.

Subsequently, the retrofitting device 108 may transfer and store all the sessions being handled by the subsequent processor group, such as the second application processor group 112, onto the retrofitted first application processor group 110. In one implementation, a session module 114 may transfer the sessions being handled by the second application processor group 112 based on associated session data. In another implementation, the network entities 106 may further include at least one consistent interface between the first application processor group 110 and the second application processor group 112 to allow the transfer of session data. It will be understood that while the retrofitted first application processor group 110 is isolated from the rest of the processor cluster by imposing isolation rules on various interfaces, such as internet protocol (IP) switches, between the first application processor group 110 and other application processor groups, in one implementation, the isolation rules are not imposed on the consistent interface to allow the transfer of session data.

In addition to the preservation of the session data, in an embodiment, the session module 114 may also switch control of the second application processor group 112 to the retrofitted first application processor group 110. It will be understood that the switching of control between two application processor groups 110 and 112 may include switching the control of the processes from one application processor group onto the other.

Once the control of the processes, associated with the communication network 104, is switched to the retrofitted first application processor group 110, the second application processor group 112, i.e., the processor group to be retrofitted, is taken offline and retrofitted with the application software in the manner as described above. According to an implementation, in the meanwhile, the retrofitted first application processor group 110 can then be activated for handling the communication services that were previously being handled by the second application processor group 112.

It would be appreciated that in a similar manner, other subsequent application processor groups can be updated, where the session of the subsequent application processor groups can be preserved on one or more retrofitted application processor groups.

FIG. 2 illustrates exemplary components of the retrofitting device 108 for retrofitting of the processor cluster with the application software, as per one implementation of the present subject matter. In said implementation, the retrofitting device 108 includes one or more processor(s) 202, interface(s) 204, and a memory 206 coupled to the processor 202. The processor 202 can be a single processing unit or a number of units, all of which could also include multiple computing units. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is configured to fetch and execute computer-readable instructions and data stored in the memory 206.

The interfaces 204 may include a variety of software and hardware interfaces, for example, interface for peripheral device(s), such as a keyboard, a mouse, an external memory, and a printer. Further, the interfaces 204 may enable the retrofitting device 108 to communicate with other computing devices, such as the other retrofitting systems (not shown) in the communication network 104.

The memory 206 may include any computer-readable medium known in the art including, for example, volatile memory such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 also includes module(s) 208 and data 210.

The module(s) 208 include routines, programs, objects, components, data structures, etc., which perform particular tasks or implement particular abstract data types. The module(s) 208 further includes the session module 114, a retrofitting module 212, and other module(s) 214. The other module(s) 214 may include programs or coded instructions that supplement applications and functions of the retrofitting device 108.

On the other hand, the data 210, amongst other things, serves as a repository for storing data processed, received, and generated by one or more of the module(s) 208. The data 210 includes, for example, processor data 216, application software data 218, and other data 220. The other data 220 includes data generated as a result of the execution of one or more modules in the other module(s) 214.

As mentioned earlier, to retrofit the processor cluster, the retrofitting device 108 divides the processor cluster into a plurality of application processor groups, for example, the first application processor group 110 and the second application processor group 112. In one implementation, the retrofitting module 212 in the retrofitting device 108 may divide the processor cluster into the plurality of application processor groups based on a plurality of rules stored in the processor data 216. For example, based on the rules stored in the processor data 216, the retrofitting module 212 may divide the processor cluster into a plurality of application processor groups based on the numerical identifiers associated with each application processor in the processor cluster or the configurations of the application processors, or a combination thereof. In said example, the configurations of the application processors include active configuration and standby configuration. Further, the information in relation to the numerical identifiers or configuration data of the application processors can also be stored in the processor data 216.

Once the division is achieved, in an embodiment, the retrofitting module 212 further installs the application software on one of the application processor groups from the plurality of application processor groups. The application software may include, but is not limited to, application software for implementing any additional functionality, a new version or release of the application software, patches, and updates. In an embodiment of the present subject matter, the application software is stored in the application software data 218 in the retrofitting device 108. In one example, the retrofitting module 212 commences with the installation of the application software on the first application processor group 110. The rules for the commencement of retrofitting may also be predefined and included in the processor data 216.

Further, the retrofitting module 212 operationally isolates the retrofitted application processor group, for example, the first application processor group 110, from other application processors within the processor cluster. As mentioned earlier, the isolation achieved by the retrofitting module is to be understood as a logical separation, in which the processes running on the retrofitted application processor group are incapable of interacting with the other processes running in the processor cluster, for example, the processes running on non-retrofitted application processor groups. In one embodiment, the retrofitting module 212 achieves the isolation of the retrofitted application processor group based on certain isolation rules stored in the other data 220. The isolation rules include, for example, configuration changes in the settings of the various interfaces between the application processor groups and modification in the firewall settings of the retrofitted application processor group.

In an embodiment, after achieving the isolation of the retrofitted application processor group from the rest of the processor cluster, the retrofitting module 212 initializes the application software on the retrofitted application processor group. As mentioned earlier, the initialization of the application software brings the application software into a ready-to-run state on the retrofitted application processor group. In such a state, the application software is capable of providing and handling communication services as soon as the retrofitted application processor group is activated and the application software is executed. Once the application software is initialized, the retrofitted application processor group, such as the first application processor group 110, may resume implementing the one or more functionalities related to the communication network 104.

According to an aspect of the present subject matter, to complete the retrofitting of the rest of the application processor groups in the processor cluster, the retrofitting module 212 identifies a subsequent application processor group, such as the second application processor group 112, for retrofitting the application software. Once identified, the session module 114 preserves the sessions being handled by the subsequent application processor group. In one implementation, the session module 114 transfers and stores the session data, such as the active call session data, active packet exchange session data, identification data associated with connected terminal devices, associated with the subsequent application processor group onto the retrofitted application processor group. In an example, the session module 114 may preserve the session of the second application processor group 112 based on the associated session data stored in other data 220.

According to an embodiment, at least one consistent interface is provided between the retrofitted and the subsequent application processor groups, such that the isolation rules applied by the retrofitting module 212 during isolation of the retrofitted application processor group are not applicable to the consistent interface. In said embodiment, the session module 114 may achieve the preservation of the session data of the subsequent application processor group on the retrofitted application processor group through the aforementioned consistent interface.

Further, subsequent to the preservation of the session data, the session module 114 switches the control of the subsequent application processor group to the retrofitted application processor group. With the switching of control to the retrofitted application processor group, the application processors in the retrofitted application processor group are made operational, by running the updated version of the application software retrofitted thereon. In addition, with the session data of the subsequent application processor group preserved on the retrofitted application processor group, the application software on the retrofitted application processor group begins handling one or more services handled by the subsequent application processor group. The subsequent application processor group, on the other hand, is brought offline upon resigning control to the retrofitted application processor group, and is retrofitted with the application software in the same manner as described above.

Once retrofitted with the required application software, the subsequent application processor group can also be activated and can be used in conjunction with the other retrofitted application processor groups. In an implementation, when the retrofitted application processor groups are made operational to service the terminal devices, such retrofitted application processor groups remain isolated from the other application processor groups, for example, non-retrofitted application processor groups, in the processor cluster to prevent any communication between the retrofitted application processor groups running one version of the application software and the other application processor groups running a different version of the application software.

In another implementation, when the retrofitted application processor group, with the application software initialized thereon, is isolated from the rest of the application processors in the processor cluster, the session module 114 preserves the sessions running on all other application processor groups in the processor cluster on the retrofitted application processor group. In said implementation, the retrofitting module 212 brings the other application processor groups offline and retrofits these application processor groups with the application software. In the meanwhile, the retrofitted application processor group having the sessions of the other application processor groups is made operational to service the terminal devices associated with the other application processor groups.

Further, in an embodiment in which the processor cluster is divided into more than two application processor groups, the rest of the application processor groups can be retrofitted by the retrofitting device 108 in the same manner as described above to achieve retrofitting of all the application processors in the processor cluster with the application software.

As described previously, for retrofitting application software, the processor cluster is divided into a plurality of application processor groups. In case the processor cluster in the communication network 104 is implemented as a plurality of mated sets, each of the mated sets may have at least one application processor in standby configuration and at least one application processor in active configuration. For the purpose of explanation, the application processors in standby configuration are referred to as standby application processors, whereas those in active configuration are referred to as active application processors.

An active application processor can be understood as an application processor actively participating in communication based operations within the communication network 104, such as call processing, and resource allocation. A standby application processor, on the other hand, can be understood as an application processor configured to be in a ready-to-run state for handling the communication services of the communication network 104. In one implementation, the standby application processor can be provided as a back-up processor to assume the processing responsibility of the active application processor in the event of failure of the active application processor. Such an implementation provides redundancy, fault tolerance, and reliability to the telecommunication system 100.

As mentioned earlier, in an implementation, the retrofitting module 212 divides the processor cluster into the plurality of application processor groups based on the standby or active configurations of the application processors. In such a case, the retrofitting module 212 may divide the processor cluster into a first application processor group 110 having standby application processors of the mated sets, and a second application processor group 112 having active application processors of the mated sets. The present example has been discussed assuming that the mated sets within the processor cluster include one active and one standby application processor. In one implementation, the retrofitting module 212 retrofits the first application processor group 110 having the standby application processors, and subsequently, isolates the retrofitted first application processor group 110. Further, the session module 114 preserves the sessions running on the second application processor group 112 and switches control of the second application processor group 112 onto the first application processor group 110. Subsequently, the retrofitting module 212 can retrofit the second application processor groups 112 with the required application software.

It would appreciated that in a similar manner as described above, the mated sets within the processor cluster may include a plurality of standby and active application processors. In such implementation, the processor cluster can be divided into first, second, third, and subsequent numbered application processor groups. These groups would either be active application processor groups or standby application processor groups. Further, the retrofitting module 212 may first install the application software on one or more standby application processor groups. The manner in which the one or more standby application processor groups are selected can be based on predefined rules which can be stored in the processor data 216. Subsequently, the retrofitting module 212 isolates the retrofitted standby application processor groups. The session module 114 preserves the sessions of the other application processor groups, for example, the active application processor groups, onto the retrofitted standby application processor groups, and the other application processor groups can be retrofitted with the required application software.

It would be appreciated by a person skilled in the art, that the retrofitting of the processor cluster, as described in the present implementation, can also be initiated with the active application processor groups without deviating from the scope of the present subject matter. In case the retrofitting is initiated with the active application processor group, the session module 114 may switch the processes being handled by the active application processor group to the standby application processor group. In an example, the session module 114 can identify the processes associated with the active application processor group, to be switched to the standby application processor group. In such an implementation, the session module 114 may periodically synchronize the session data associated with the terminal devices connected to the active application processor group on the active as well as the standby application processor group. Hence, the retrofitting module 212 can first retrofit the active application processor group after the active application processor group is taken offline by the session module 114. In such a case, the standby application processor group has the session data for handling the terminal devices. The retrofitting of the application processors with the required application software can then be implemented based on the description provided above.

In one implementation, after the retrofitting of all the application processor groups is achieved, the last retrofitted application processor group may acquire a standby configuration, whereas the rest of the application processor groups continue to run in the active configuration. In another implementation, after all the application processor groups are retrofitted and brought online, various communication related services can be distributed among the active application processor groups to balance the load. In an example, the load of certain communication services is distributed among the application processors handling those communication services.

It will be understood that although the subject matter is described with reference to the processor cluster being implemented as mated sets of application processors having active as well as standby application processors, in another embodiment of the subject matter, the processor cluster may be implemented as a plurality of active application processor.

In said embodiment, to commence retrofitting, the retrofitting module 212 can divide the processor cluster into a plurality of active application processor groups. In an example, the division of the processor cluster is achieved in such a way that each active application processor group is capable of handling load of other active application processor groups in the processor cluster without being overloaded or limiting the communication services to the terminal devices. Further, while retrofitting, the session module 114 can switch the control of a first active application processor group to a subsequent active application processor group and then the first active application processor group can be taken offline and retrofitted in the same manner as described above. The rest of the application processors in the processor cluster can also be retrofitted in the same manner as described earlier.

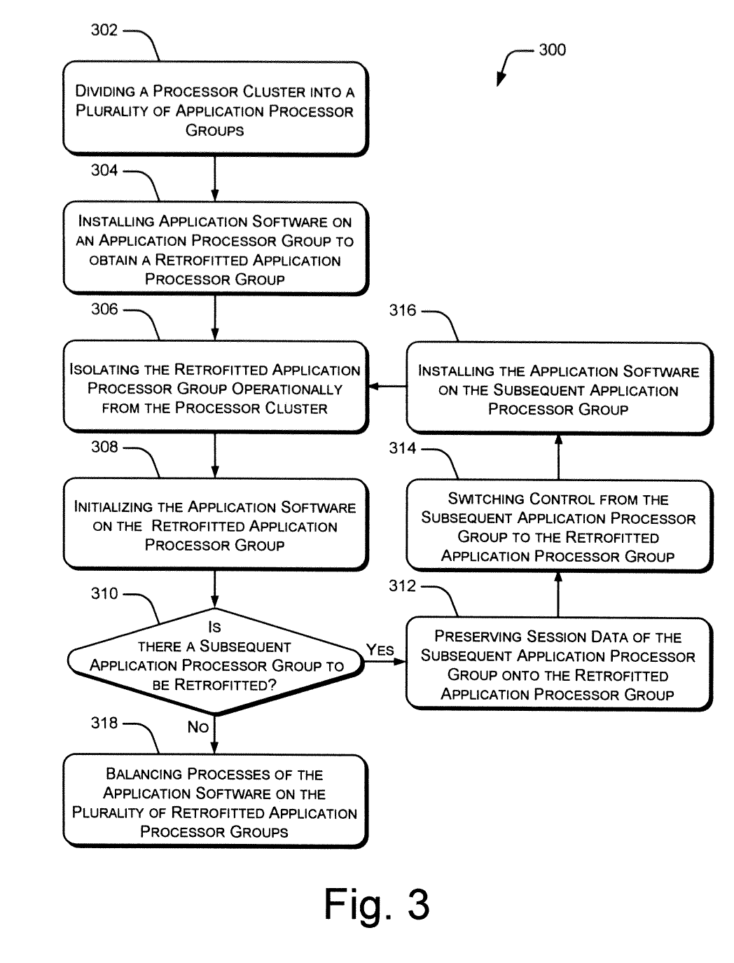

FIG. 3 illustrates an exemplary method 300 for retrofitting a processor cluster with application software in a communication network, such as the communication network 104. According to an embodiment, the method 300 is executed by a retrofitting device, such as the retrofitting device 108. The order in which the method is described is not intended to be construed as a limitation, and any number of the described method blocks can be combined in any order to implement the method, or an alternative method. Additionally, individual blocks may be deleted from the method without departing from the spirit and scope of the subject matter described herein. Furthermore, the methods can be implemented in any suitable hardware, software, firmware, or combination thereof.

A person skilled in the art will readily recognize that steps of the method can be performed by programmed computers. Herein, some embodiments are also intended to cover program storage devices, for example, digital data storage media, which are machine or computer readable and encode machine-executable or computer-executable programs of instructions, wherein said instructions perform some or all of the steps of the described method. The program storage devices may be, for example, digital memories, magnetic storage media such as a magnetic disks and magnetic tapes, hard drives, or optically readable digital data storage media.

At block 302, the processor cluster within a network entity, such as the network entity 106, is divided into a plurality of application processor groups. In an implementation, the processor cluster is divided into the plurality of application processor groups based on numerical identifiers of the application processors or the configurations of the various application processors in the processor cluster, or a combination thereof. For example, the retrofitting module 212 divides the processor cluster into a plurality of application processor groups, such as a first application processor group 110 and second application processor group 112. The division of the processor cluster can be based on the information, such as numerical identifiers and configuration data, associated with the application processors, and stored in a processor data, for example, the processor data 216.

At block 304, the application software is installed on one of the plurality of application processor groups. As mentioned earlier, the application processor group having the application software installed thereon is referred to as the retrofitted application processor group. The application software may be, for example, a single application software or a plurality of application software for implementing any additional functionality, a new version or release of the application software, patches, and updates. For example, the retrofitting module 212 installs the application software on the application processor group, such as the first processor group 110. In said example, the first application processor group 110 may be either the active application processor group or the standby application processor group, having active application processors and standby application processors, respectively.

At block 306, the retrofitted application processor group, on which the application software is installed, is operationally isolated from the rest of the application processor groups in the processor cluster. For example, the retrofitting module 212 isolates the retrofitted application processor group based on a plurality of isolation rules. In one implementation, the isolation rules can be stored in other data, such as the other data 220. The retrofitting module 212 may apply the isolation rules on various interfaces connecting the application processor groups with each other within the processor cluster.

As also mentioned previously, the isolation of the retrofitted application processor group is achieved to prevent any interaction between the processes of one version of the application software running on the retrofitted application processor group and a different version of the application software being executed on the other application processor groups. Such an interaction of the processes of the different versions of the application software, which is prevented by isolating the various application processor groups, may occur at the initialization of the application software on the retrofitted application processor group, as explained with reference to block 308.

At block 308, the application software installed on the retrofitted application processor group is initialized. For example, the retrofitting module 212 initializes the application software to complete the retrofitting of the application software installed on the application processor group, such as the first application processor group 110. According to an aspect, the initialization of the application software on the retrofitted application processor group brings the processes of the application software in a ready-to-run state. In such a state, the application software is capable of handling the communication services in the communication network 104 when made operational on the retrofitted application processor group.

At block 310, it is determined whether a subsequent application processor group to be retrofitted with the application software is present. For example, the session module 114, determines whether a subsequent application processor group, such as the second application processor group 112, is to be retrofitted. If, at block 310, it is determined that the no subsequent application processor group in the processor cluster is to be retrofitted (“No” path from block 310), then the retrofitting of the processor cluster is considered to have been completed (block 318).

On the other hand, if it is determined that a subsequent application processor group to be retrofitted is present (“Yes” path from block 310), then sessions of the subsequent application processor group are preserved onto the previously retrofitted application processor group (block 312). For example, the session module 114 preserves the session of the second application processer group 112 onto the first application processor group 110. The session module 114 may preserve the session of the second application processor group 112 based on the associated session data stored in other data 220.

At block 314, control of the subsequent application processor group is switched to the retrofitted application processor group. For example, the session module 114 switches the control of the processes of the second application processor group 112 to the first application processor group 110.

At block 316, the application software is installed on the subsequent application processor group. In an implementation, the application software is installed on the subsequent application processor group by the retrofitting module 212, in the same manner as described at block 304.

Further, in an implementation, for retrofitting the subsequent application processor group, blocks 306, block 308, and block 310 of the method 300 are repeated to achieve the retrofitting of the processor cluster. Further, the method 300 is repeated, until all the application processor groups in the processor cluster are retrofitted with the application processor.

In an implementation, when all the application processor groups in the processor cluster have been retrofitted with the application software (“No” path from block 310) then, as mentioned earlier, the retrofitting of the processor cluster is considered to be complete. In such a case, at block 318, the communication services being handled by the plurality of application processor groups in the processor cluster can be distributed amongst the plurality of retrofitted application processor groups to balance the load. Further, in an implementation, the last retrofitted application processor group is configured to function in the standby mode, i.e., each application processor in the last retrofitted application processor group is put in the standby mode.

It will be understood that although the above description is provided assuming that the application processor group including the standby application processors is retrofitted first, the method can be executed by beginning with the retrofitting of an application processor group having active application processors. In such a case, before the installation of the application software on the application processor group is achieved, the control of the application processor group is switched to the standby application processor group. Further, the retrofitting of the processor cluster, in this case too, is achieved in the same manner as described in FIG. 3.

Although implementations for retrofitting a processor cluster in a communication network have been described in language specific to structural features and/or methods, it is to be understood that the appended claims are not necessarily limited to the specific features or methods described. Rather, the specific features and methods are disclosed as exemplary implementations for retrofitting the processor cluster.

1. A method for retrofitting a processor cluster, the method comprising:
dividing the processor cluster into a plurality of application processor groups, wherein the processor cluster comprises a plurality of application processors;
retrofitting application software on an application processor group selected from the plurality of application processor groups, to obtain a retrofitted application processor group;
preserving at least one session of a subsequent application processor group on the retrofitted application processor group; and
retrofitting the application software onto the subsequent application processor group.

2. The method as claimed in claim 1, wherein the retrofitting the application software on the application processor group comprises:
installing the application software on the application processor group;
isolating the application processor group from other application processor groups in the plurality of application processor groups; and
initializing the application software on the isolated application processor group.

3. The method as claimed in claim 1, wherein the preserving the session of the subsequent application processor group comprises preserving session data associated with the session of the subsequent application processor group.

4. The method as claimed in claim 1, wherein the preserving further comprises switching control of at least one process from at least the subsequent application processor group to the retrofitted application processor group.

5. The method as claimed in claim 1, wherein the dividing the processor cluster is based at least on one of a numerical identifier associated with each of the plurality of application processors, and a configuration of each of the plurality of application processors.

6. The method as claimed in claim 5, wherein the configuration comprises one of an active configuration and a standby configuration of the plurality of application processors.

7. The method as claimed in claim 1 further comprising switching control of at least one process from the application processor group to the subsequent application processor group, wherein the switching is responsive to identifying the process on the application processor group from the plurality of application processor groups.

8. A retrofitting device comprising:
a retrofitting module configured to,
retrofit application software on an application processor group selected from a plurality of application processor groups in a processor cluster; and
identify a subsequent application processor group from the plurality of application processor groups; and
a session module configured to preserve session data, indicative of one or more sessions controlled by the subsequent application processor group, from the subsequent application processor group.

9. The retrofitting device as claimed in claim 8, wherein the session module is further configured to:
switch control of at least one process identified on the application processor group to the subsequent application processor group; and
taking the application processor group offline for retrofitting.

10. The retrofitting device as claimed in claim 8, wherein the session module is further configured to:
transfer the session data from the subsequent application onto a previously retrofitted application processor group; and
switch control of at least one process on the subsequent application processor group to the previously retrofitted application processor group.

11. The retrofitting device as claimed in claim 8, wherein the retrofitting module is further configured to divide the processor cluster into the plurality of application processor groups.

12. The retrofitting device as claimed in claim 11, wherein the retrofitting module is configured to divide the processor cluster based at least on one of numerical identifier of each application processor in the processor cluster and configuration of each application processor in the processor cluster.

13. The retrofitting device as claimed in claim 12, wherein the configuration of each application processor comprises one of an active configuration and a standby configuration.

14. The retrofitting device as claimed in claim 8, wherein the retrofitting module is further configured to:
install the application software on the application processor group;
isolate the application processor group from the plurality of application processor group; and
activate the application software on the application processor group.

15. The retrofitting device as claimed in 8, wherein the retrofitting module is further configured to implement at least one consistent interface between at least the subsequent application processor group and a previously retrofitted application processor group for transferring the session data.

16. A computer-readable medium having embodied thereon a computer program for executing a method for retrofitting a plurality of processor groups, the method comprising:
updating application software on an application processor group from amongst a plurality of application processor groups to obtain a retrofitted application processor group;
identifying at least one subsequent application processor group from amongst the plurality of application processor groups for retrofitting;
storing, at least in part, sessions of the subsequent application processor group on the retrofitted application group; and
retrofitting the subsequent application processor group with the application software.

17. The computer-readable medium as claimed in claim 16 further comprising transferring control of at least one process, identified on the application processor group, to the subsequent application processor group.

18. The computer-readable medium as claimed in claim 16, wherein the updating comprises:
dividing the processor cluster into the plurality of application processor groups;
installing the application software on the application processor group from among the plurality of application processor groups;
isolating the application processor group from the plurality of application processor groups; and
initializing application on the application processor group.

19. The computer readable medium as claimed in claim 18, wherein the dividing the processor cluster is based on at least one of numerical identifier of each application processor in the processor cluster and configuration of each application processor in the processor cluster.

20. The computer-readable medium as claimed in claim 16, wherein the storing comprises switching control of at least one process from the subsequent application processor group onto the application processor group.
